(19) United States
(12) Patent Application Publication
(10) Pub. No.: US 2017/0368705 A1
(43) Pub. Date: Dec. 28, 2017

(54) Tube Cutter with Automatically Feeding Function

(71) Applicant: Yu-Zhu Liao, Taichung City (TW)

(72) Inventor: Yu-Zhu Liao, Taichung City (TW)

(21) Appl. No.: 15/432,973

(22) Filed: Feb. 15, 2017

(30) Foreign Application Priority Data
Jun. 24, 2016 (TW) 105209523
Jan. 20, 2017 (TW) 106201083

(51) Int. Cl. B26D 3/16; B26B 25/00

(52) U.S. Cl. CPC B26D 3/169; B26B 25/005

(57) ABSTRACT

A tube cutter includes a main body, a holder, a guide bolt and two rollers. The main body has a wall provided with a screw hole. The holder is slidably mounted on the main body and is provided with a through hole. A cutting wheel is rotatably mounted on the holder and corresponding between the two rollers. The guide bolt is screwed through the screw hole of the main body and extends through the through hole of the holder. The guide bolt has a first end provided with a rotation portion and a second end provided with a resting portion. An elastic member is mounted on the guide bolt and is biased between the resting portion and the holder. The two rollers are rotatably mounted on the main body.

### BACKGROUND OF THE INVENTION

### 1. Field of the Invention

The present invention relates to a cutter and, more particularly, to a tube cutter for cutting a tube.

### 2. Description of the Related Art

A conventional tube cutter comprises a substantially U-shaped main body having a first end provided with a screw hole, a cutting wheel mounted on a second end of the main body, a slide movably mounted on the main body, two rollers mounted on the slide and aligning with the cutting wheel, and a threaded rod screwed through the screw hole of the main body and having a first end resting on the two rollers, and a control knob secured on a second end of the threaded rod. In operation, when the threaded rod is rotated by the control knob, the threaded rod is moved axially relative to the main body to drive the two rollers which drive the slide to move on the main body, so that the two rollers are moved relative to the cutting wheel. Thus, when the tube cutter is mounted on a tube, the two rollers rest on the tube. Then, the threaded rod is rotated by the control knob, and the two rollers are moved toward the cutting wheel, so that the tube is clamped between the two rollers and the cutting wheel. Then, the main body is held by the user's hand and is rotated relative to the tube, so that the cutting wheel is revolved on the tube so as to shear the tube gradually and successively until the tube is cut. However, the conventional tube cutter does not have an automatically feeding function so that the user has to rotate the control knob successively to move the two rollers to press the tube during the shearing process, thereby causing inconvenience to the user, and thereby wasting the energy and working time.

### BRIEF SUMMARY OF THE INVENTION

The primary objective of the present invention is to provide a tube cutter with an automatically feeding function.

In accordance with the present invention, there is provided a tube cutter comprising a main body, a holder, a guide bolt and two rollers. The main body includes a horizontal portion and a vertical portion. The main body is provided with a horizontal receiving channel and a vertical receiving channel. The horizontal portion has a wall provided with a screw hole. The holder is slidably mounted in the horizontal receiving channel of the main body. The holder has a mediate position provided with a through hole aligning with the screw hole. The holder is provided with a mounting groove, and a cutting wheel is rotatably mounted in the mounting groove and corresponding between the two rollers. The mounting groove has a first sidewall provided with a through bore and a second sidewall provided with a screw bore coaxial with the through bore. The cutting wheel is provided with a shaft bore, and a screw extends through the through bore and the shaft bore and is screwed into the screw bore. The guide bolt is screwed through the screw hole of the main body and extends through the through hole of the holder. The guide bolt has a first end provided with a rotation portion protruding from the screw hole of the main body and a second end provided with a resting portion protruding from the through hole of the holder. An elastic member is mounted on the guide bolt and is biased between the resting portion and the holder. The two rollers are rotatably mounted on the main body.

According to the primary advantage of the present invention, the holder is pushed by the elastic force of the elastic member, so that the cutting wheel is fed toward the tube automatically during the cutting process, so as to shear the tube successively until the tube is cut, thereby facilitating the user operating the tube cutter to cut the tube.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a tube cutter in accordance with the first preferred embodiment of the present invention.

FIG. 2 is an exploded perspective view of the tube cutter as shown in FIG. 1.

FIG. 3 is a cross-sectional view of the tube cutter as shown in FIG. 1.

FIG. 4 is a schematic operational view of the tube cutter as shown in FIG. 3.

FIG. 5 is a schematic operational view of the tube cutter as shown in FIG. 4.

FIG. 6 is a schematic operational view of the tube cutter as shown in FIG. 5.

FIG. 7 is a schematic operational view of the tube cutter as shown in FIG. 6.

FIG. 8 is a schematic operational view of the tube cutter as shown in FIG. 7.

FIG. 9 is a perspective view of a tube cutter in accordance with the second preferred embodiment of the present invention.

FIG. 10 is an exploded perspective view of the tube cutter as shown in FIG. 9.

FIG. 11 is a cross-sectional view of the tube cutter as shown in FIG. 9.

FIG. 12 is a perspective view of a tube cutter in accordance with the third preferred embodiment of the present invention.

FIG. 13 is an exploded perspective view of the tube cutter as shown in FIG. 12.

FIG. 14 is a cross-sectional view of the tube cutter as shown in FIG. 12.

FIG. 15 is a cross-sectional view of the tube cutter taken along line F-F as shown in FIG. 14.

FIG. 16 is a perspective view of a tube cutter in accordance with the fourth preferred embodiment of the present invention.

FIG. 17 is an exploded perspective view of the tube cutter as shown in FIG. 16.

FIG. 18 is a cross-sectional view of the tube cutter as shown in FIG. 16.

FIG. 19 is a cross-sectional view of the tube cutter taken along line B-B as shown in FIG. 18.

FIG. 20 is a schematic operational view of the tube cutter as shown in FIG. 18.

FIG. 21 is a schematic operational view of the tube cutter as shown in FIG. 20.

FIG. 22 is a schematic operational view of the tube cutter as shown in FIG. 21.

### DETAILED DESCRIPTION OF THE INVENTION

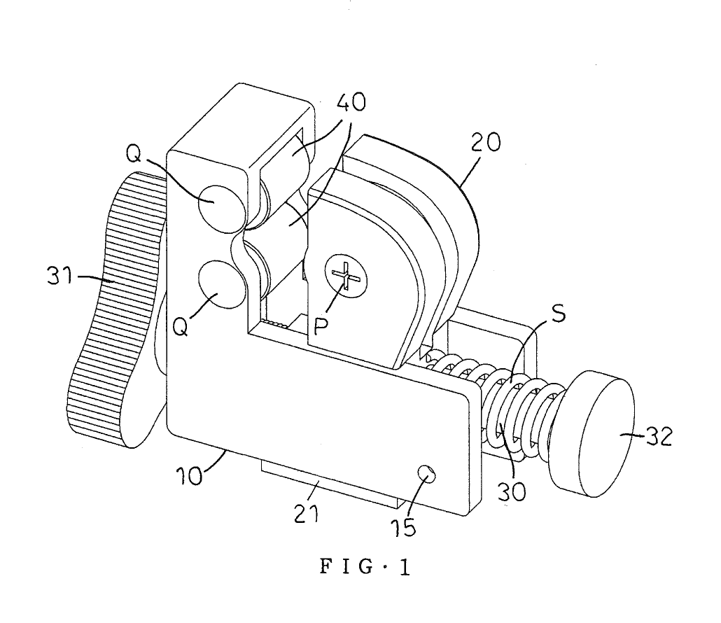

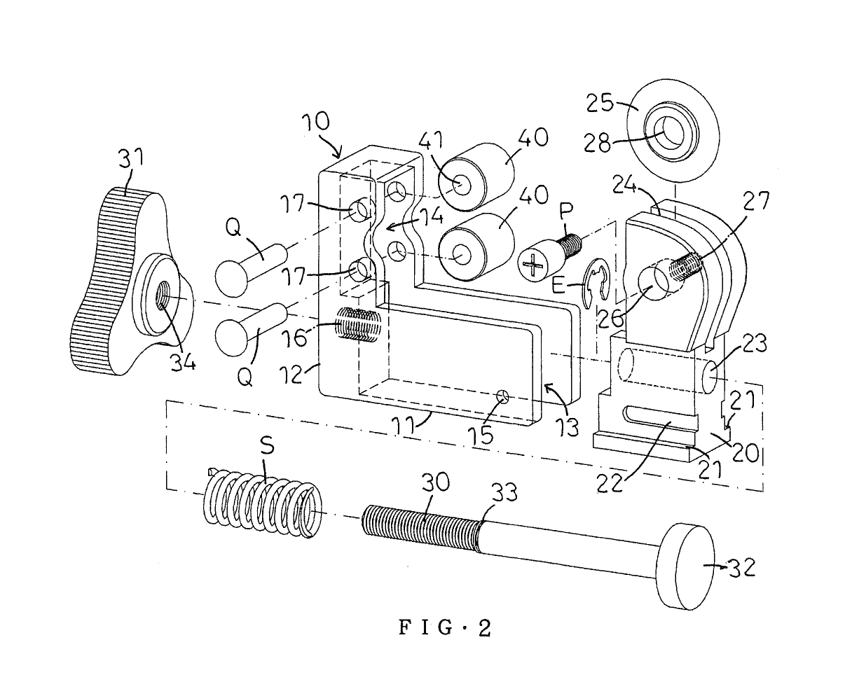

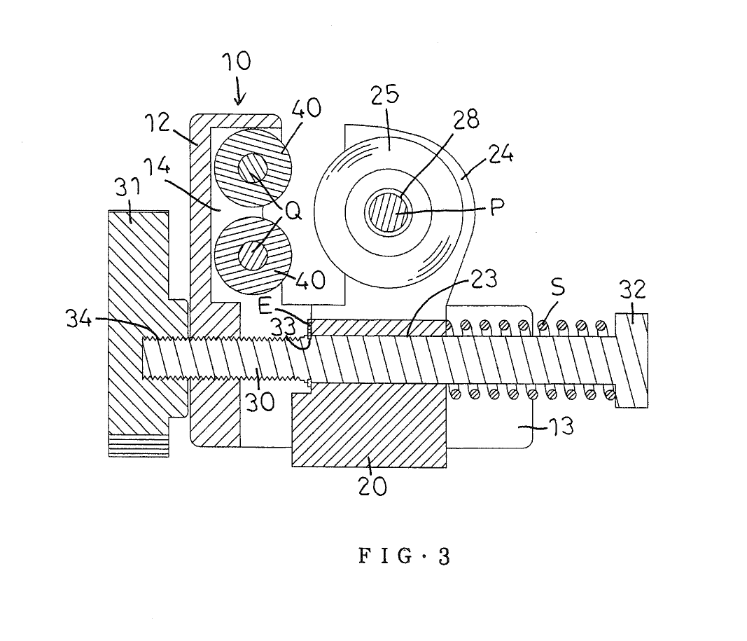

Referring to the drawings and initially to FIGS. 1-3, a tube cutter in accordance with the preferred embodiment of the present invention comprises a main body 10, a holder 20, a guide bolt 30 and two rollers 40.

The main body 10 has a substantially L-shaped profile and includes a horizontal portion 11 and a vertical portion 12. The main body 10 is provided with a horizontal receiving channel 13 and a vertical receiving channel 14. The horizontal portion 11 has a wall corresponding to the vertical portion 12 and provided with a screw hole 16. The vertical receiving channel 14 has two sidewalls each provided with two pivot holes 17.

The holder 20 is slidably mounted in the horizontal receiving channel 13 of the main body 10 so that the holder 20 is moved forward and backward in the horizontal receiving channel 13 of the main body 10. The holder 20 has a mediate position provided with a through hole 23 aligning with the screw hole 16. The holder 20 is provided with a mounting groove 24, and a cutting wheel 25 is rotatably mounted in the mounting groove 24 and corresponding between the two rollers 40. The mounting groove 24 has a first sidewall provided with a through bore 26 and a second sidewall provided with a screw bore 27 coaxial with the through bore 26. The cutting wheel 25 is provided with a shaft bore 28, and a screw “P” extends through the through bore 26 and the shaft bore 28 and is screwed into the screw bore 27.

The guide bolt 30 is screwed through the screw hole 16 of the main body 10 and extends through the through hole 23 of the holder 20. The guide bolt 30 has a first end provided with a rotation portion 31 protruding from the screw hole 16 of the main body 10 and a second end provided with a resting portion 32 protruding from the through hole 23 of the holder 20. The guide bolt 30 is rotated by the rotation portion 31. An elastic member “S” is mounted on the guide bolt 30 and is biased between the resting portion 32 and the holder 20.

The two rollers 40 are mounted on the main body 10 by two pivot members “Q”. Each of the two rollers 40 is provided with a shaft hole 41. The two pivot members “Q” extend through the pivot holes 17 of the main body 10 and the shaft holes 41 of the two rollers 40, so that the two rollers 40 are rotatable freely in the vertical receiving channel 14 of the main body 10.

In the preferred embodiment of the present invention, the holder 20 has a bottom provided with two stepped rails 21 resting on a bottom of the horizontal portion 11 and has a side provided with a slideway 22, the horizontal receiving channel 13 has a sidewall provided with an aperture 15, and a positioning pin (not shown) extends through the aperture 15 of the main body 10 and positioned in the slideway 22 of the holder 20. Thus, the holder 20 is moved forward and backward in the horizontal receiving channel 13 of the main body 10 by provision of the two stepped rails 21 and the slideway 22.

In the preferred embodiment of the present invention, the resting portion 32 and the guide bolt 30 are formed integrally. The rotation portion 31 has a center provided with a screw hole 34 screwed onto the guide bolt 30. The guide bolt 30 has a mediate position provided with an annular groove 33 for mounting a substantially E-shaped snap ring “E”. In assembly, the elastic member “S” is initially mounted on the guide bolt 30, the guide bolt 30 then extends through the through hole 23 of the holder 20, the snap ring “E” is then snapped onto the annular groove 33 of the guide bolt 30, the guide bolt 30 is then screwed through the screw hole 16 of the main body 10, the screw hole 34 of the rotation portion 31 is then screwed onto the guide bolt 30, and the rotation portion 31 and the guide bolt 30 are then combined integrally by an adhesive.

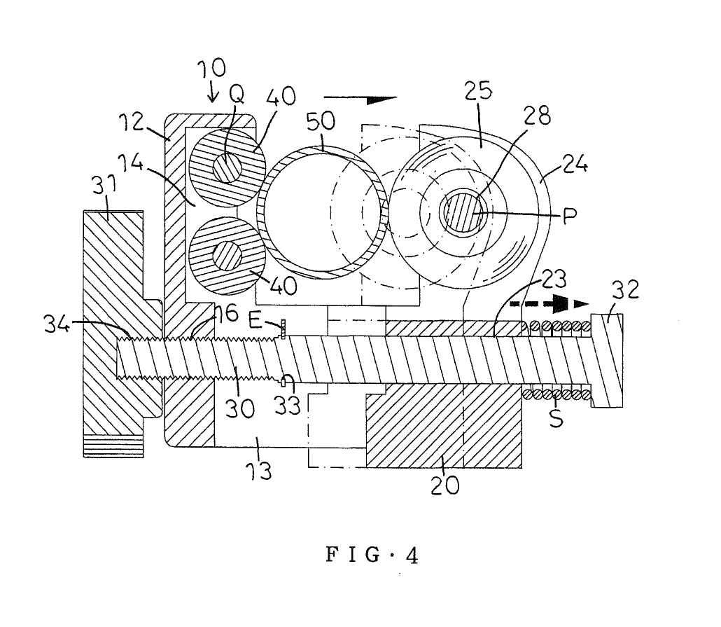

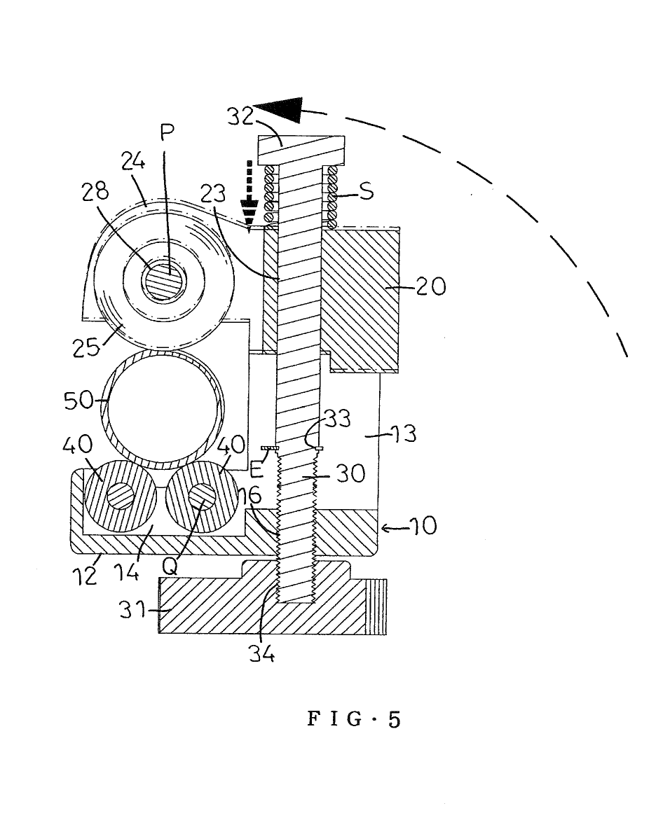

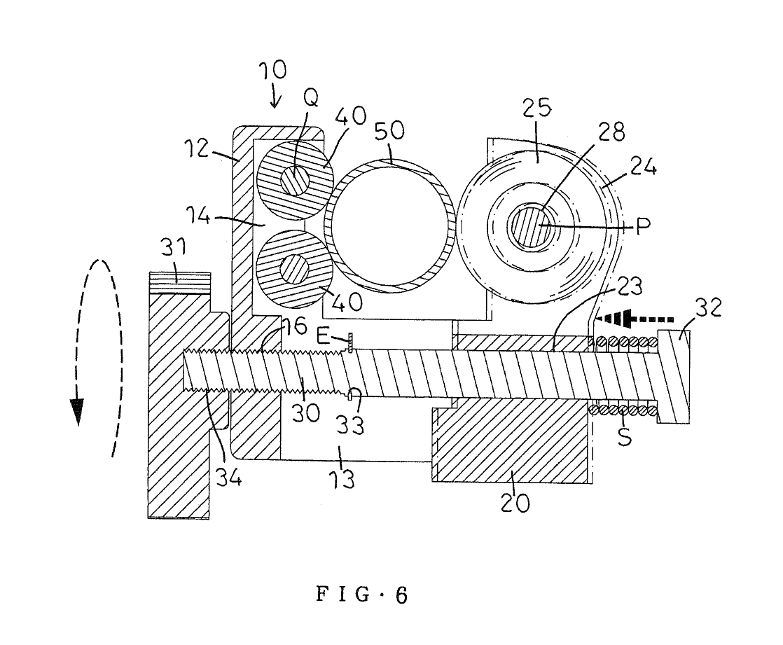

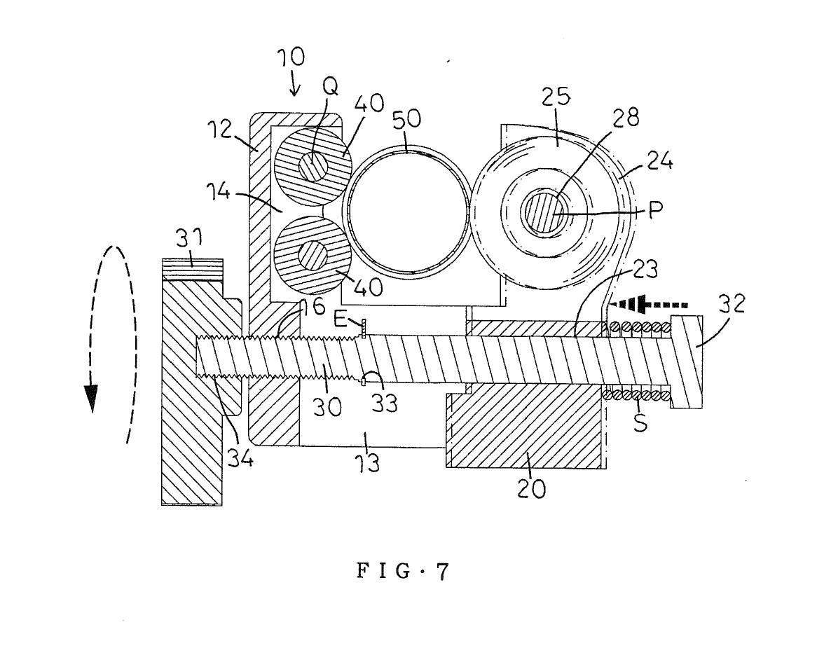

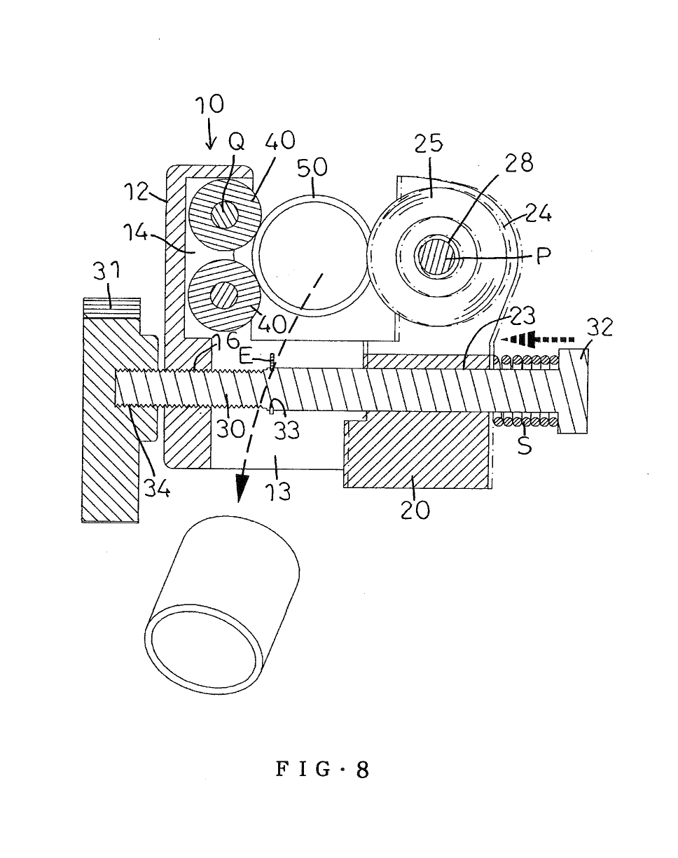

In operation, referring to FIGS. 4-8 with reference to FIGS. 1-3, when the tube cutter is mounted on a workpiece, such as a tube 50, the tube 50 is inserted between the two rollers 40 and the cutting wheel 25, so that the two rollers 40 and the cutting wheel 25 form a three-point contact state to support the tube 50 solidly and stably. At this time, the holder 20 is pressed by the tube 50 to compress the elastic member “S” as shown in FIG. 4. Then, the main body 10 and the holder 20 are held by the user's fingers and are rotated relative to the tube 50, so that the cutting wheel 25 is revolved on the tube 50 reciprocally so as to shear the tube 50 gradually and successively until the tube 50 is cut as shown in FIG. 8. At the same time, the holder 20 is pushed by the elastic force of the elastic member “S”, so that the cutting wheel 25 is fed toward the tube 50 automatically during the cutting process, so as to shear the tube 50 successively. It is appreciated that, the guide bolt 30 is screwed through the screw hole 16 of the main body 10, and the elastic member “S” is biased between the resting portion 32 of the guide bolt 30 and the holder 20, so that when the guide bolt 30 is rotated by the rotation portion 31, the guide bolt 30 is displaced relative to the main body 10, and the resting portion 32 of the guide bolt 30 is moved forward or backward to compress or loosen the elastic member “S”, so as to regulate the tension of the elastic member “S”. In such a manner, the elastic force of the elastic member “S” is regulated by rotation of the guide bolt 30 so as to correspond to and match the wall thickness of the tube 50, so that the cutting wheel 25 engages the tube 50 closely and tightly.

Accordingly, the holder 20 is pushed by the elastic force of the elastic member “S”, so that the cutting wheel 25 is fed toward the tube 50 automatically during the cutting process, so as to shear the tube 50 successively until the tube 50 is cut, thereby facilitating the user operating the tube cutter to cut the tube 50.

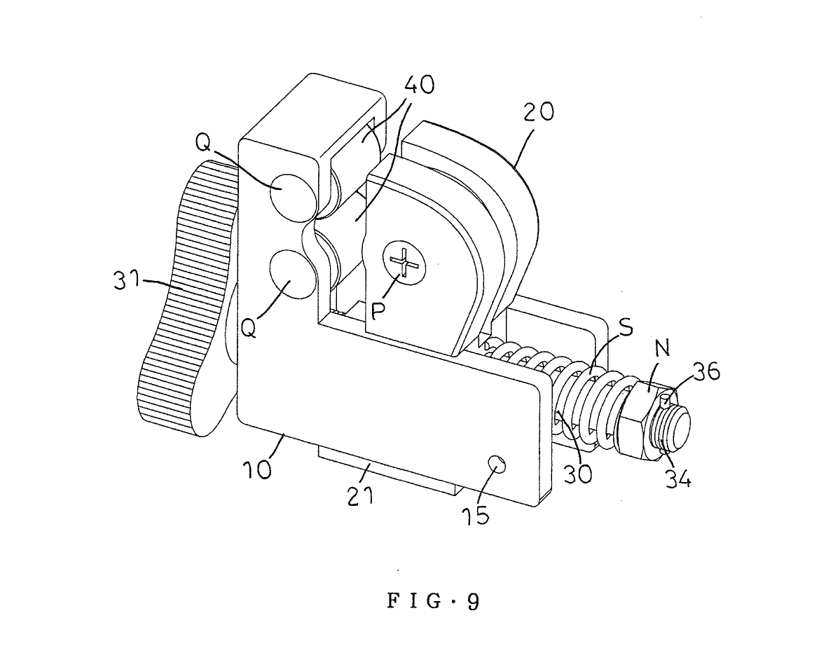

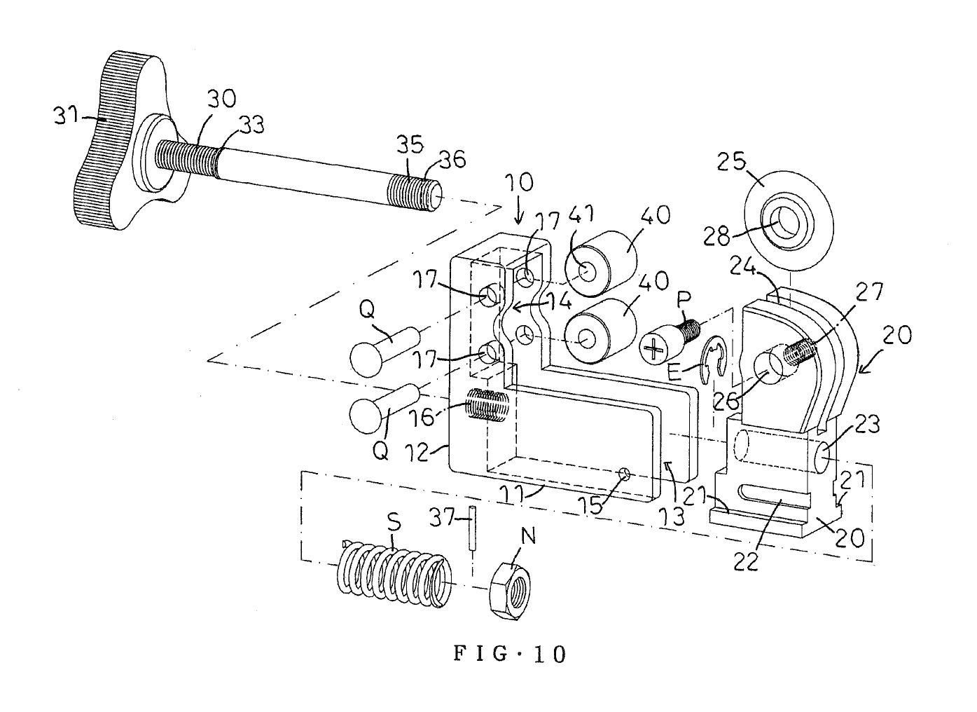

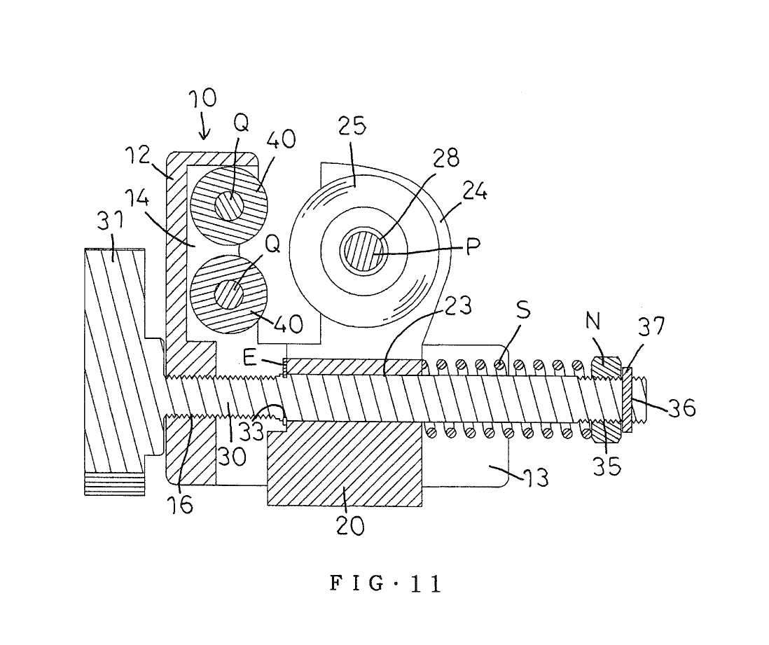

Referring to FIGS. 9-11, the rotation portion 31 and the guide bolt 30 are formed integrally. The second end of the guide bolt 30 is provided with an external thread 35 and a pin hole 36. The resting portion is a nut “N” screwed onto the external thread 35 of the guide bolt 30, and a pin 37 extends through the pin hole 36 of the guide bolt 30 and rests on the nut “N” to prevent the nut “N” from being detached from the guide bolt 30. In assembly, the guide bolt 30 is initially screwed through the screw hole 16 of the main body 10, the snap ring “E” is then snapped onto the annular groove 33 of the guide bolt 30, the guide bolt 30 then extends through the through hole 23 of the holder 20, the elastic member “S” is then mounted on the guide bolt 30, the nut “N” is then screwed onto the external thread 35 of the guide bolt 30, and the pin 37 then extends through the pin hole 36 of the guide bolt 30 and rests on the nut “N”.

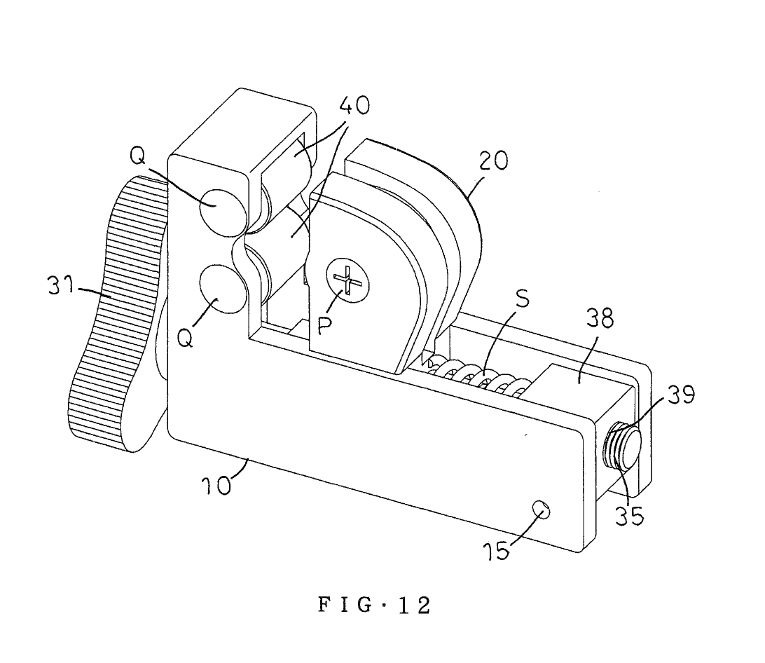

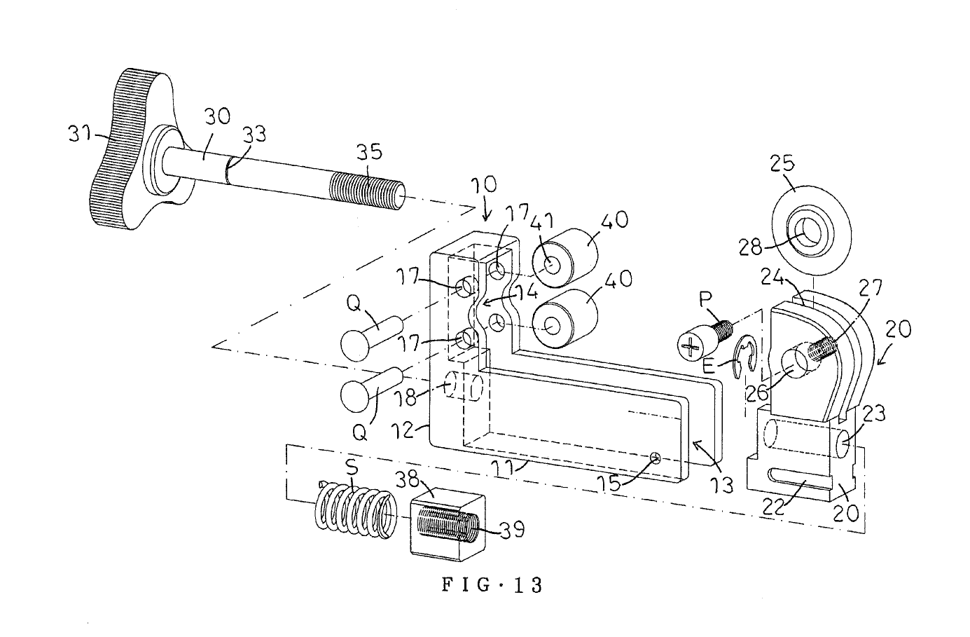

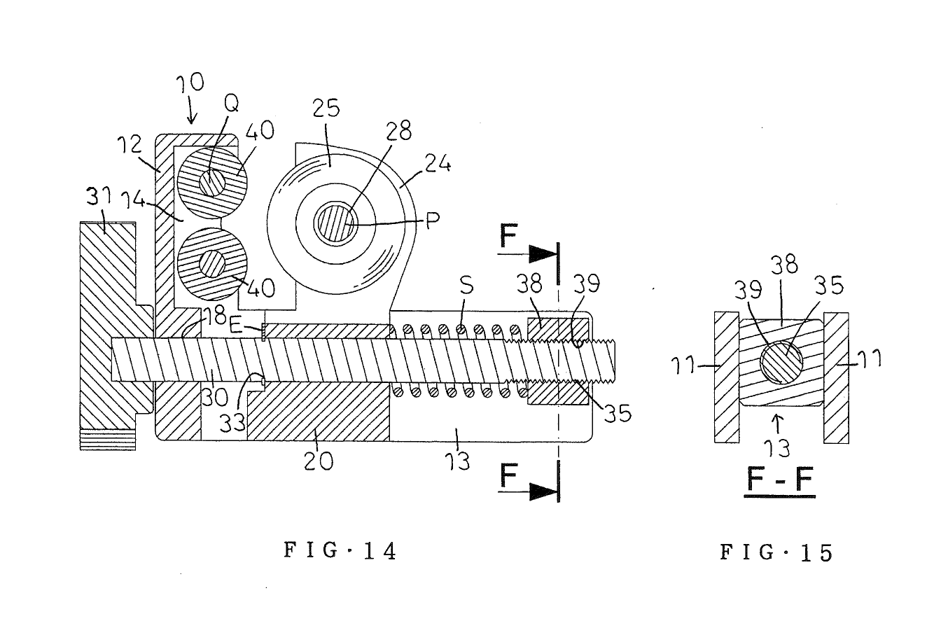

Referring to FIGS. 12-15, the horizontal portion 11 has a wall corresponding to the vertical portion 12 and provided with a through hole 18. The guide bolt 30 extends through the through hole 18 of the main body 10 and extends through the through hole 23 of the holder 20. The guide bolt 30 has a first end provided with a rotation portion 31 protruding from the through hole 18 of the main body 10 and a second end provided with an external thread 35. The guide bolt 30 is rotated by the rotation portion 31. A slide 38 is mounted on the guide bolt 30 and received in the horizontal receiving channel 13 of the main body 10. The slide 38 is provided with an internal thread 39 screwed onto the external thread 35 of the guide bolt 30 so that the slide 38 is moved forward and backward in the horizontal receiving channel 13 of the main body 10 by rotation of the guide bolt 30. An elastic member “S” is mounted on the guide bolt 30 and is biased between the slide 38 and the holder 20.

In assembly, the guide bolt 30 initially extends through the through hole 18 of the main body 10, the snap ring “E” is then snapped onto the annular groove 33 of the guide bolt 30, the guide bolt 30 then extends through the through hole 23 of the holder 20, the elastic member “S” is then mounted on the guide bolt 30, and the external thread 35 of the guide bolt 30 is then screwed into the internal thread 39 of the slide 38, so that the elastic member “S” is biased between the slide 38 and the holder 20.

It is appreciated that, the elastic member “S” is biased between the slide 38 and the holder 20, so that when the slide 38 is moved forward by a normal rotation of the guide bolt 30, the elastic member “S” is compressed to have a greater elastic force, and when the slide 38 is moved backward by a reverse rotation of the guide bolt 30, the elastic member “S” is loosened to have a smaller elastic force. In such a manner, the elastic force of the elastic member “S” is regulated by rotation of the guide bolt 30 so as to correspond to and match the wall thickness of the tube 50, so that the cutting wheel 25 engages the tube 50 closely and tightly.

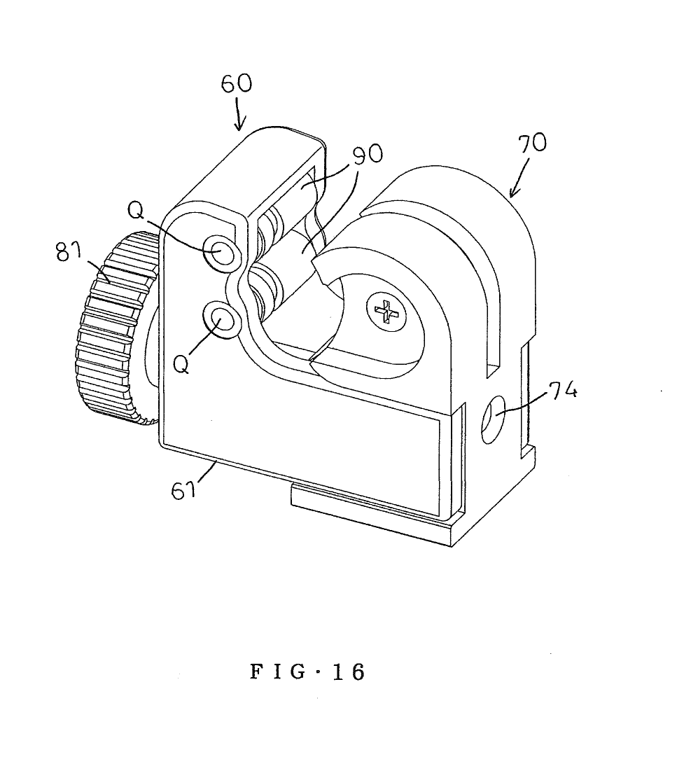

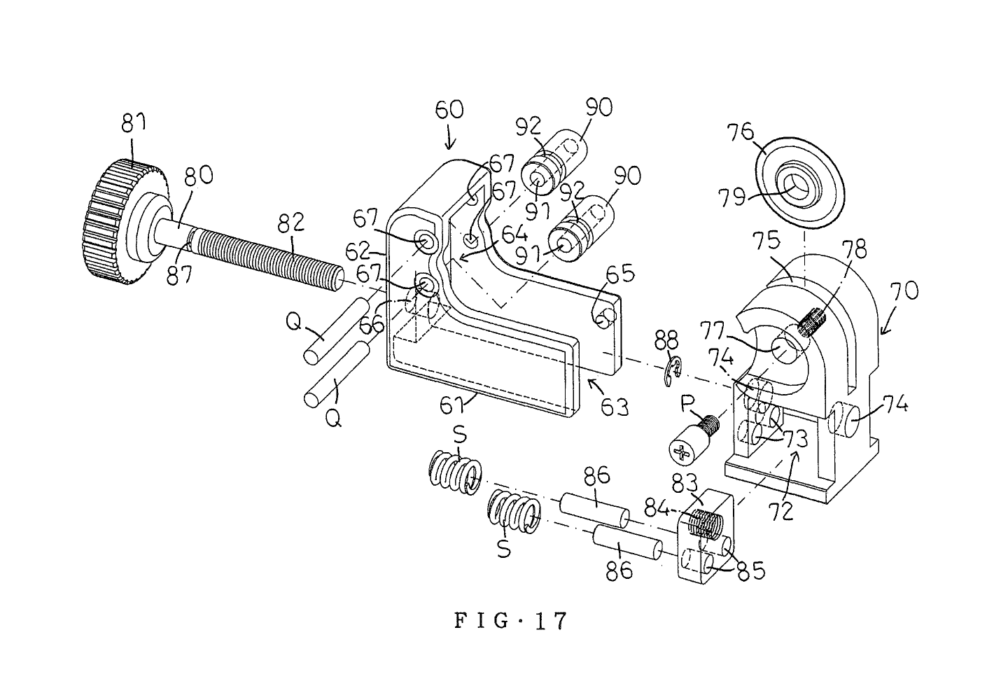

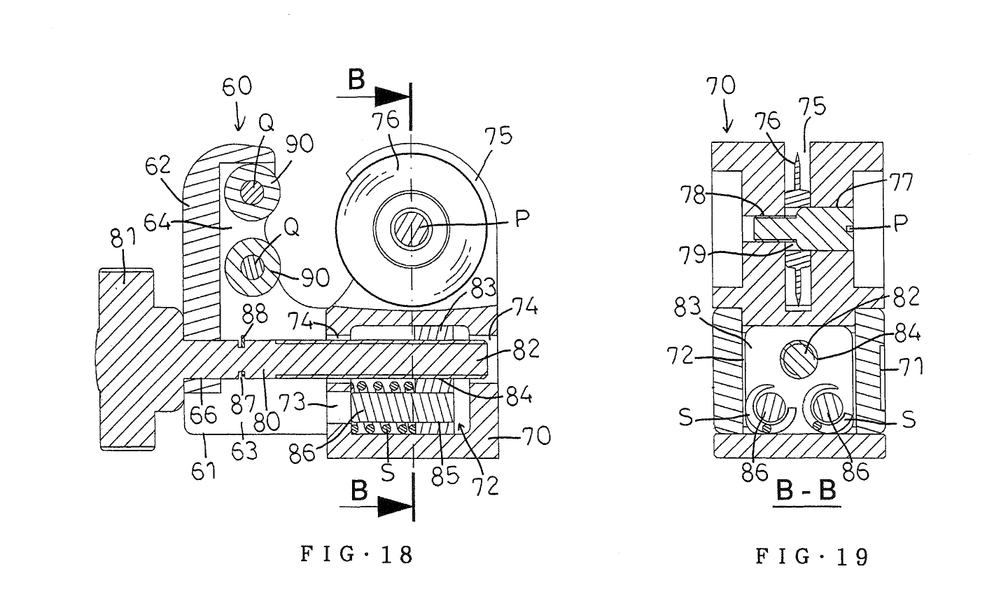

Referring to FIGS. 16-19, a tube cutter in accordance with another preferred embodiment of the present invention comprises a main body 60, a holder 70, a guide bolt 80 and two rollers 90.

The main body 60 has a substantially L-shaped profile and includes a horizontal portion 61 and a vertical portion 62. The main body 60 is provided with a horizontal receiving channel 63 and a vertical receiving channel 64. The horizontal portion 61 has a wall corresponding to the vertical portion 62 and provided with a through hole 66. The vertical receiving channel 64 has two sidewalls each provided with two pivot holes 67.

The holder 70 is slidably mounted in the horizontal receiving channel 63 of the main body 60 so that the holder 70 is moved forward and backward in the horizontal receiving channel 63 of the main body 60. The holder 70 is provided with a receiving space 72, and a slide 83 is received in the receiving space 72 of the holder 70. The holder 70 is provided with two positioning holes 73 connected to the receiving space 72. The holder 70 is provided with two through holes 74 located at two sidewalls of the receiving space 72 and aligning with the through hole 66 of the main body 60. The holder 70 is provided with a mounting groove 75, and a cutting wheel 76 is rotatably mounted in the mounting groove 75 and corresponding between the two rollers 90. The mounting groove 75 has a first sidewall provided with a through bore 77 and a second sidewall provided with a screw bore 78 coaxial with the through bore 77. The cutting wheel 76 is provided with a shaft bore 79, and a screw “P” extends through the through bore 77 and the shaft bore 79 and is screwed into the screw bore 78.

The slide 83 is provided with an internal thread 84 and two mounting holes 85. Two positioning rods 86 extend through the two positioning holes 73 of the holder 70 and the two mounting holes 85 of the slide 83. Two elastic members “S” are mounted on the two positioning rods 86 and are biased between the slide 83 and the holder 70.

The guide bolt 80 extends through the through hole 66 of the main body 60, the two through holes 74 of the holder 70 and the internal thread 84 of the slide 83. The guide bolt 80 has a first end provided with a rotation portion 81 protruding from the through hole 66 of the main body 60 and a second end provided with an external thread 82 screwed through the internal thread 84 of the slide 83. In assembly, the external thread 82 of the guide bolt 80 initially extends through the through hole 66 of the main body 60 and a front one of the two through holes 74 of the holder 70, is then screwed through the internal thread 84 of the slide 83, and then extends through a rear one of the two through holes 74 of the holder 70. The guide bolt 80 has a mediate position provided with an annular groove 87 for mounting a snap ring 88.

The two rollers 90 are mounted on the main body 60 by two pivot members “Q”. Each of the two rollers 90 is provided with a shaft hole 91. The two pivot members “Q” extend through the pivot holes 67 of the main body 60 and the shaft holes 91 of the two rollers 90, so that the two rollers 90 are rotatable freely in the vertical receiving channel 64 of the main body 60. Each of the two rollers 90 has a periphery provided with a groove 92 to avoid a protruding edge of a tube to be cut.

In the preferred embodiment of the present invention, the holder 70 has a side provided with a slideway 71, the horizontal receiving channel 63 of the main body 60 has a sidewall provided with an aperture 65, and a positioning pin (not shown) extends through the aperture 65 of the main body 60 and positioned in the slideway 71 of the holder 70.

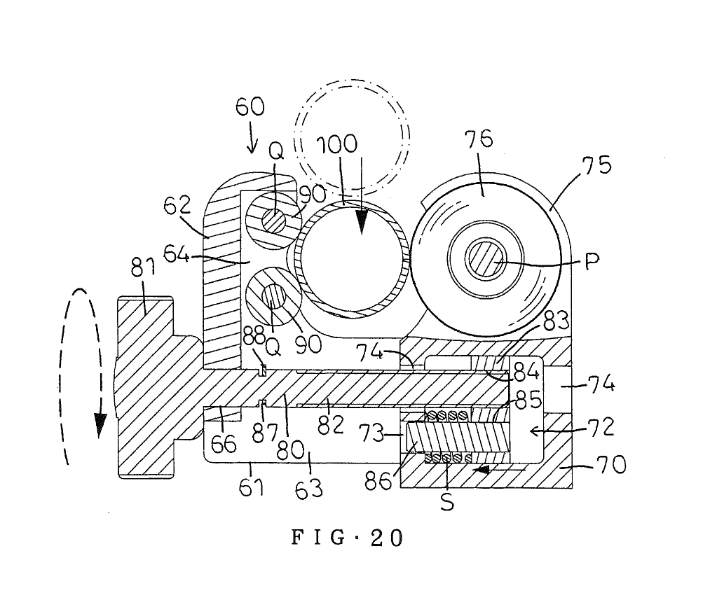

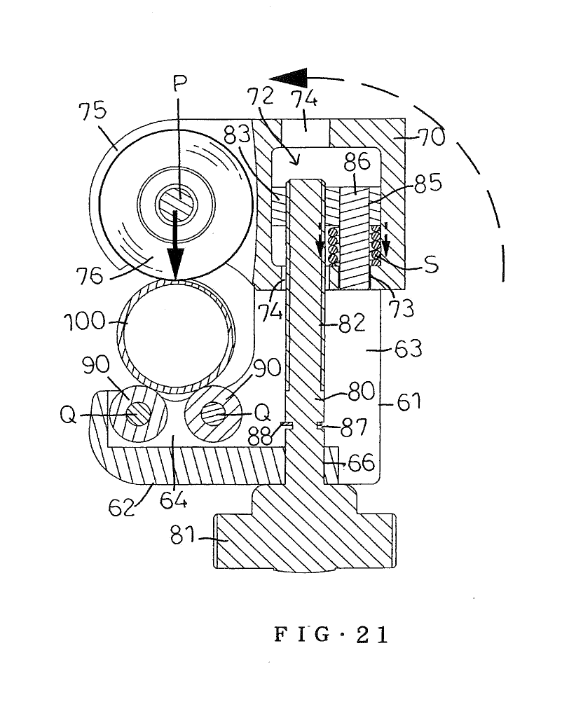

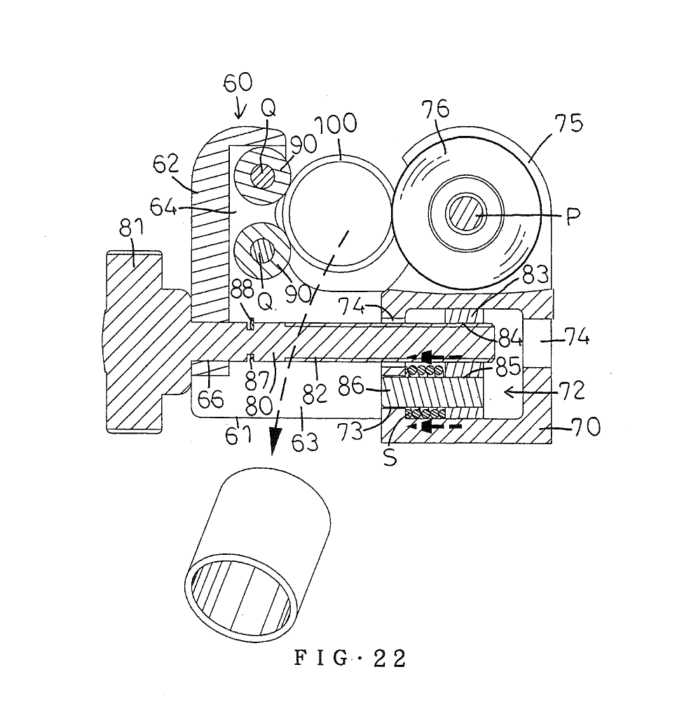

In operation, referring to FIGS. 20-22 with reference to FIGS. 16-19, when the tube cutter is mounted on a workpiece, such as a tube 100, the tube 100 is inserted between the two rollers 90 and the cutting wheel 76, so that the two rollers 90 and the cutting wheel 76 form a three-point contact state to support the tube 100 solidly and stably. At this time, the holder 70 is pressed by the tube 100 to compress the elastic member “S”. Then, the main body 60 and the holder 70 are held by the user's fingers and are rotated relative to the tube 100, so that the cutting wheel 76 is revolved on the tube 100 reciprocally so as to shear the tube 100 gradually and successively until the tube 100 is cut as shown in FIG. 22. At the same time, the holder 70 is pushed by the elastic force of the elastic member “S”, so that the cutting wheel 76 is fed toward the tube 100 automatically during the cutting process, so as to shear the tube 100 successively. It is appreciated that, when the guide bolt 80 is rotated by the rotation portion 81, the slide 83 is displaced in the receiving space 72 of the holder 70, and is moved forward or backward to compress or loosen the elastic member “S”, so as to regulate the tension of the elastic member “S”. In such a manner, the elastic force of the elastic member “S” is regulated by rotation of the guide bolt 80 so as to correspond to and match the wall thickness of the tube 100, so that the cutting wheel 76 engages the tube 100 closely and tightly.

Accordingly, the slide 83 is hidden in the receiving space 72 of the holder 70 to reduce the volume and weight of the tube cutter, thereby facilitating the user carrying the tube cutter.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A tube cutter comprising:
a main body, a holder, a guide bolt and two rollers;
wherein:
the main body includes a horizontal portion and a vertical portion;
the main body is provided with a horizontal receiving channel and a vertical receiving channel;
the horizontal portion has a wall provided with a screw hole;
the holder is slidably mounted in the horizontal receiving channel of the main body;
the holder has a mediate position provided with a through hole aligning with the screw hole;
the holder is provided with a mounting groove;
a cutting wheel is rotatably mounted in the mounting groove and corresponding between the two rollers;
the mounting groove has a first sidewall provided with a through bore and a second sidewall provided with a screw bore coaxial with the through bore;
the cutting wheel is provided with a shaft bore;
a screw extends through the through bore and the shaft bore and is screwed into the screw bore;
the guide bolt is screwed through the screw hole of the main body and extends through the through hole of the holder;
the guide bolt has a first end provided with a rotation portion protruding from the screw hole of the main body and a second end provided with a resting portion protruding from the through hole of the holder;
an elastic member is mounted on the guide bolt and is biased between the resting portion and the holder; and
the two rollers are rotatably mounted on the main body.

2. The tube cutter of claim 1, wherein the holder has a bottom provided with two stepped rails resting on a bottom of the horizontal portion and has a side provided with a slideway, the horizontal receiving channel has a sidewall provided with an aperture, and a positioning pin extends through the aperture of the main body and positioned in the slideway of the holder.

3. The tube cutter of claim 1, wherein:
the resting portion and the guide bolt are formed integrally;
the rotation portion has a center provided with a screw hole screwed onto the guide bolt; and
the elastic member is initially mounted on the guide bolt, the guide bolt then extends through the through hole of the holder and is screwed through the screw hole of the main body, the screw hole of the rotation portion is then screwed onto the guide bolt, and the rotation portion and the guide bolt are then combined integrally by an adhesive.

4. The tube cutter of claim 1, wherein:
the rotation portion and the guide bolt are formed integrally;
the second end of the guide bolt is provided with an external thread and a pin hole;
the resting portion is a nut screwed onto the external thread of the guide bolt;
a pin extends through the pin hole of the guide bolt and rests on the nut to prevent the nut from being detached from the guide bolt;
the guide bolt is initially screwed through the screw hole of the main body and extends through the through hole of the holder, the elastic member is then mounted on the guide bolt, the nut is then screwed onto the external thread of the guide bolt, and the pin then extends through the pin hole of the guide bolt and rests on the nut.

5. A tube cutter comprising:
a main body, a holder, a guide bolt and two rollers;
wherein:
the main body includes a horizontal portion and a vertical portion;
the main body is provided with a horizontal receiving channel and a vertical receiving channel;
the horizontal portion has a wall provided with a through hole;
the holder is slidably mounted in the horizontal receiving channel of the main body;
the holder has a mediate position provided with a through hole aligning with the screw hole;
the holder is provided with a mounting groove;
a cutting wheel is rotatably mounted in the mounting groove and corresponding between the two rollers;
the mounting groove has a first sidewall provided with a through bore and a second sidewall provided with a screw bore coaxial with the through bore;
the cutting wheel is provided with a shaft bore;
a screw extends through the through bore and the shaft bore and is screwed into the screw bore;
the guide bolt extends through the through hole of the main body and extends through the through hole of the holder;
the guide bolt has a first end provided with a rotation portion protruding from the through hole of the main body and a second end provided with an external thread;
a slide is mounted on the guide bolt and received in the horizontal receiving channel of the main body;
the slide is provided with an internal thread screwed onto the external thread of the guide bolt so that the slide is moved forward and backward in the horizontal receiving channel of the main body by rotation of the guide bolt;
an elastic member is mounted on the guide bolt and is biased between the slide and the holder; and
the two rollers are rotatably mounted on the main body.

6. The tube cutter of claim 5, wherein the holder has a side provided with a slideway, the horizontal receiving channel has a sidewall provided with an aperture, and a positioning pin extends through the aperture of the main body and positioned in the slideway of the holder.

7. A tube cutter comprising:
a main body, a holder, a guide bolt and two rollers;
wherein:
the main body includes a horizontal portion and a vertical portion;
the main body is provided with a horizontal receiving channel and a vertical receiving channel;
the horizontal portion has a wall provided with a through hole;
the holder is slidably mounted in the horizontal receiving channel of the main body;
the holder is provided with a receiving space;
a slide is received in the receiving space of the holder;
the holder is provided with two positioning holes connected to the receiving space;
the holder is provided with two through holes located at two sidewalls of the receiving space and aligning with the through hole of the main body;
the holder is provided with a mounting groove;
a cutting wheel is rotatably mounted in the mounting groove and corresponding between the two rollers;
the slide is provided with an internal thread and two mounting holes;
two positioning rods extend through the two positioning holes of the holder and the two mounting holes of the slide;
two elastic members are mounted on the two positioning rods and are biased between the slide and the holder;
the guide bolt extends through the through hole of the main body, the two through holes of the holder and the internal thread of the slide;
the guide bolt has a first end provided with a rotation portion protruding from the through hole of the main body and a second end provided with an external thread screwed through the internal thread of the slide; and
the two rollers are rotatably mounted on the main body.

8. The tube cutter of claim 7, wherein the guide bolt has a mediate position provided with an annular groove for mounting a snap ring.

9. The tube cutter of claim 7, wherein the holder has a side provided with a slideway, the horizontal receiving channel has a sidewall provided with an aperture, and a positioning pin extends through the aperture of the main body and positioned in the slideway of the holder.

10. The tube cutter of claim 7, wherein each of the two rollers has a periphery provided with a groove to avoid a protruding edge of a tube to be cut.
